(19) United States
(12) Patent Application Publication
(10) Pub. No.: US 2008/0259134 A1
(43) Pub. Date: Oct. 23, 2008

(54) PRINT HEAD LAMINATE

(75) Inventors: Philip H. Harding, Albany, OR (US); Patrick V. Boyd, Albany, OR (US); Paul J. Benning, Corvallis, OR (US); Manish Giri, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/738,366

(22) Filed: Apr. 20, 2007

(51) Int. Cl. B41J 2/045

(52) U.S. Cl. 347/72

(57) ABSTRACT

A print head laminate includes a flexible glass layer between an adhesive layer and an electrical conductor.

### BACKGROUND

Piezo inkjet print heads are sometimes formed using photolithography, anodic bonding and glass back grinding. Such processes may be expensive and time consuming.

### BRIEF DESCRIPTION OF THE DRAWINGS

FIG. 1 is a front perspective view of a print head according to an example embodiment.

FIG. 2 is a right side elevational view of the print head of FIG. 1 according to an example embodiment.

FIG. 3 is a rear perspective view of a plurality of the print heads of FIG. 1 prior to singulation according to an example embodiment.

FIG. 4 is a front perspective view of the printed of FIG. 1 omitting portions for purposes of illustration according to an example embodiment.

FIG. 5 is a fragmentary front elevational view of the print head of FIG. 4 according to an example embodiment.

FIG. 6 is a fragmentary sectional view of another embodiment of print head of FIG. 1 according to an example embodiment.

FIGS. 7-11 are side elevational views illustrating a method for forming the print heads of FIG. 1 according to an example embodiment.

FIGS. 12-17 are side elevational views illustrating another method for forming the print heads of FIG. 1 according to an example embodiment.

### DETAILED DESCRIPTION OF THE EXAMPLE EMBODIMENTS

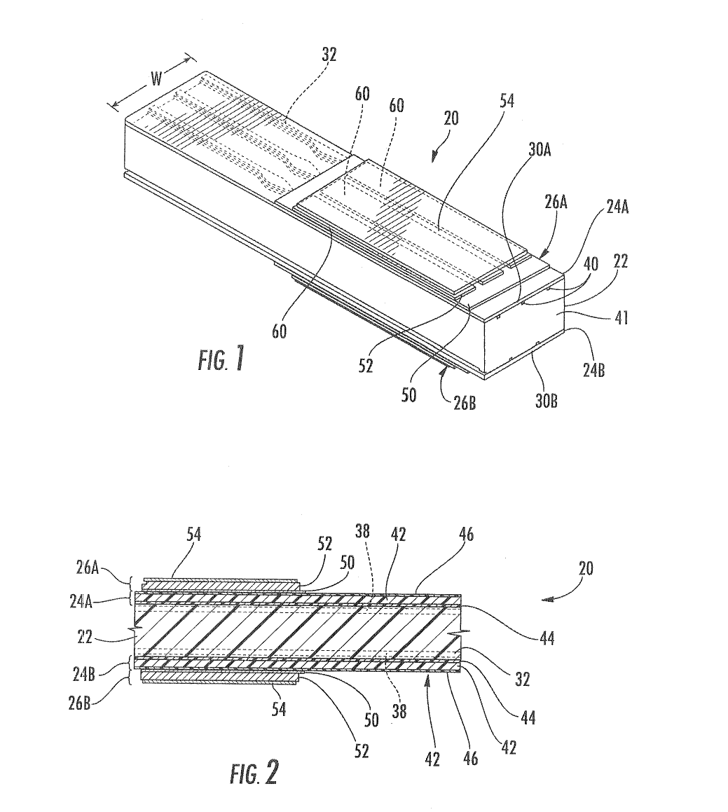

FIGS. 1-3 illustrate piezo inkjet print head 20 according to an example embodiment. Print head 20 is configured to selectively dispense or eject one or more fluids, such as one or more inks, onto a medium. Print head 20 includes substrate die or substrate 22, print head laminates 24A and 24B (collectively referred to as laminates 24), and piezo actuators 26A and 26B (collectively referred to as actuators 26).

Substrate 22 comprises a substantially planar structure formed from one or more layers of one or more materials having opposite faces 30A and 30B (collectively referred to as faces 30). As shown by FIG. 1 and further shown in FIG. 4, faces 30A and 30B each include fluidic features or channels 32. Channels 32 extend along faces 30 and along axes that are substantially parallel to the general plane along which substrate 22 extends. As shown by FIG. 4, channels 32 each include a fill chamber or portion 36 and an ejection chamber or portion 38. Fill portions 36 comprise those portions of channels 32 which are in direct fluid communication with a fluid supply or source, such as a fluid reservoir (not shown).

The ejection portions 38 comprise those portions of the channel 32 generally proximate to actuators 26 and terminating at nozzle openings 40. Nozzle openings 40 comprise orifices along nozzle edge 41 of substrate 22 through which fluid is ejected. Nozzle openings 40 have controlled or defined dimensions to regulate a volume of fluid ejected. The ejection portions 38 also have a defined geometry to assist in regulating the amount of fluid ejected through openings 40. In particular, the ejection portions 38 define a volume. Movement of an adjacent laminate 24 by an adjacent actuator 26 changes the volume to eject fluid through a corresponding opening 40.

According to one example embodiment, substrate 22 is formed from a homogenous layer of silicon into which channels 32 and openings 40 are fabricated using photolithography, etching and/or other fabrication techniques. According to yet another example embodiment, substrate 22 is formed from a homogenous layer of one or more polymeric materials into which channels 32 and openings 40 are fabricated. In one embodiment, the one or more polymeric materials comprise a thermoset polymeric material, such as an epoxy. In yet other embodiments, one or more polymeric materials comprise a thermoplastic polymeric material, such as a polyetherimide (PEI). In those embodiments in which substrate 22 is formed from a thermoplastic material, substrate 22 may exhibit enhanced ink resistance and rigidity.

Examples of low-cost high modulus polymeric materials from which substrate 22 may be injection molded include liquid crystal polymers (LCP), polysulfone (PS) and Poly-ether-ether-ketone (PEEK). Other examples of polymeric materials from which substrate 22 may be molded include: polyethylenteraphalate (PET), polyethyleneimine (PEI), Polyphenylene sulfide, (PPS) and polyisoprene (PI). In yet other embodiments, substrate 22 may be impression molded. Use of polymers to form substrate 22 may reduce the cost of print head 20, enable a wider format of print heads by avoiding or reducing silicon-based processing and harnessing improved mechanical properties of polymers such a strain to failure, facilitate rapid turn-around prototyping, and increase the degrees of freedom for fluidic architecture of channels 32.

In some embodiments, the polymeric material forming substrate 22 may additionally include a percentage of filler material. Examples of filler material include, but are not limited to, carbon, titania, metal, and glass. In those embodiments in which the polymeric material includes a filler material, substrates 22 may exhibit increased rigidity and thermal conductivity.

In one embodiment, channels 32 and openings 40 are molded into substrate 22. For example, in one embodiment, substrate 22 is injection molded. Use of injection molding facilitates varied geometries for openings 40 which may provide benefits with regard to fluid drop uniformity and/or directionality. In still other embodiments, channels 32 may be formed in substrate 22 in other fashions such as by one or more material removal techniques such as photolithography or photopatterning and etching, electromechanical machining, such as cutting, sawing, grinding and the like, or laser ablation or cutting.

In the particular example illustrated, substrate 22 has a width W of about 1 to about 9 inches. Channels 32 have a width of about 200 micrometers and a depth of about 100 micrometers. Openings 40 have a width and a depth of about 40 micrometers. In other embodiments, substrate 22 channels 32 and openings 40 may have alternative dimensions.

Laminates 24 comprise multi-layered structures joined to substrate 22 against and along opposite faces of substrate 22. Laminates 24 are formed from multiple continuous and substantially coextensive layers of materials. In one embodiment, laminates 24 have a thickness and are formed from materials such that laminates 24 are sufficiently flexible so as to be stored and distributed from rolls or reels, facilitating lower-cost fabrication of print head 20. Laminates 24 at least partially cover channels 32, support actuators 26 opposite to ejection portions 38 of channels 32 and provide flexible membranes or diaphragms configured to be moved by actuators 26 to change a volume of ejection portions 38 so as to “squeeze” or eject fluid through openings 40 via mechanical or acoustic mechanisms.

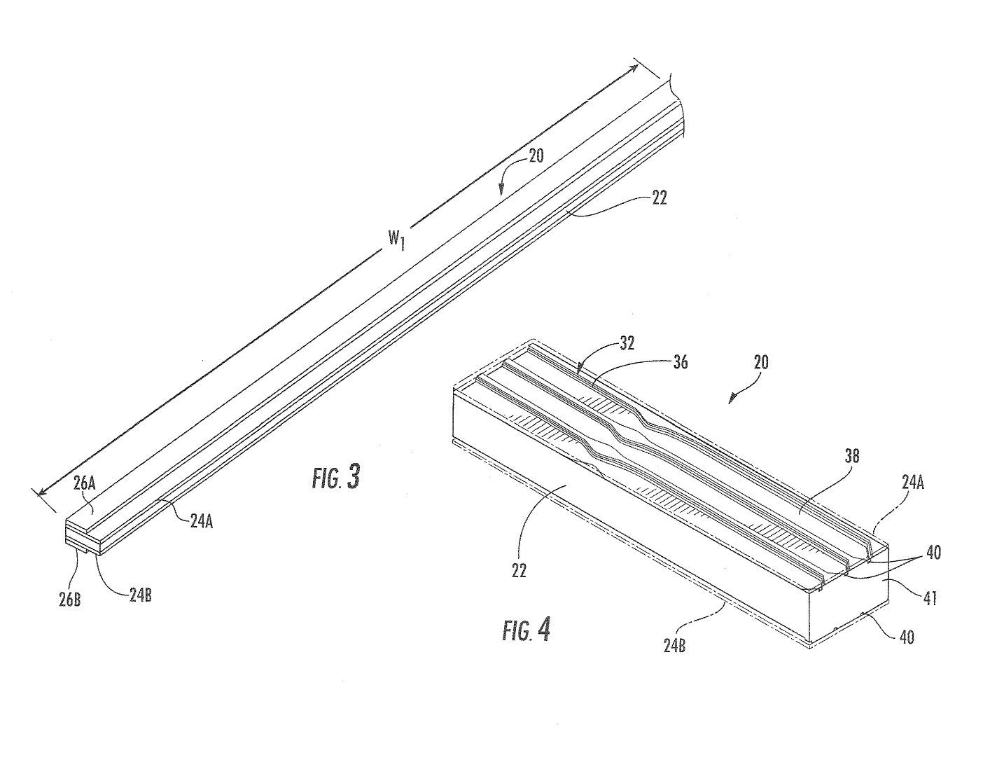

As shown by FIGS. 2 and 5, laminates 24 each include glass layer 42, adhesive layer 44 and electrical conductor 46. Glass layer 42 comprises a layer of glass dimensioned so as to be sufficiently flexible to permit actuators 26 (shown in FIG. 1) to flex or bend such glass into ejection portion 38 of channels 32 in a controlled manner. In one embodiment, glass layer 42 has a thickness of about 58 micrometers. Such thin glass sheets are commercially available from vendors such as Schott North America, Inc. of Elmsford, N.Y. According to one embodiment, glass layer 42 has a mechanical modulus of about 60 GPa and a Poisson's Ratio of about 0.25. Glass layer 42 has a coefficient of thermal expansion of between about 3 and about 9 ppm. In other embodiments, glass layer 42 may have other dimensions. Glass layer 42 provides a “ceiling” for the chamber having a very high stiffness, or modulus, so as to avoid mechanical energy losses.

Adhesive layer 44 comprises one or more layers of one or more materials adhered to glass layer 42 and configured to serve as an adhesion mechanism for securing laminate 24 to substrate 22. In one embodiment, adhesive layer 44 additionally serves as an ink barrier and relaxes interfacial stresses between glass layer 42 and substrate 22. According to one embodiment, adhesive layer 44 may comprise a layer of an epoxy material such as a photoresist like SU8 joined to an IJ5000 dry film. In one embodiment, the layer of SU8 (commercially available from MicroChem Corp. of Newton, Mass.) may have a thickness of about 9 micrometers while the IJ5000 film (commercially available from Dupont) has a thickness of about 14 micrometers. In other embodiments, adhesive layer 44 may have other thicknesses and may be formed from alternative materials.

Electrical conductor 46 comprises one or more layers of electrically conductive material on and adjacent to glass layer 42 on an opposite side of glass layer 42 as compared to adhesive layer 44. Electrical conductor 46 assists in forming an electrical potential across piezo material 52 of actuators 26, facilitating ejection of fluid through openings 40 by actuators 26. In one embodiment, electrical conductor 46 comprises a metal deposited upon glass layer 42. For example, in one embodiment, electrical conductor 46 may comprise spluttered indium tin oxide (ITO) having a thickness of about 0.2 micrometers. In other embodiments, electrical conductor 46 may comprise other electrically conductive materials and may have other dimensions.

In one embodiment, laminates 24 are individually formed and are subsequently joined to substrate 22 after fluidic features, such as channels 32 and openings 40 have been formed and substrate 22. As a result, fabrication of laminates 24 may be outsourced and laminates 24 may be more easily stored, reducing time and space for fabricating print heads 20. In those embodiments in which laminates 24 are provided on rolls, the fabrication of print heads 20 may be performed using roll-to-roll or reel-to-reel processes. In one embodiment, laminates 24 are joined to substrate 22 by curing adhesive layer 44, such as with baking, with the electrically conductive layer 46 facing away from substrate 22. In other embodiments, such joining may be formed in other manners.

Actuators 26 comprise mechanisms configured to be formed on laminates 42 so as to flex or deform portions of laminates 42 to eject fluid through openings 40 of print head 20. In the example illustrated, actuators 26 comprise piezo actuators which change shape in response to an applied electrical potential or voltage. As shown by FIG. 2, actuators 26 each include adhesive layer 50, piezo material 52 and electrical conductor 54. Adhesive layer 50 comprises a layer of adhesive material configured to adhere piezo material 52 to electrical conductor 46. As shown by FIG. 2, layer 50 is selectively deposited upon electrical conductor 46. In other embodiments, layer 50 may be continuously coated or formed across electrical conductor 46. In one embodiment, layer 50 comprises an electrically conductive adhesive material. For example, layer 50 may comprise an epoxy adhesive. In other embodiments, layer 50 may comprise other electrically conductive adhesive materials. In some embodiments, layer 50 may be omitted, wherein piezo material 52 is joined to electrical conductor 46 in other fashions.

Piezo material 52 comprises a piezoelectric ceramic or piezoelectric crystals which, when subjected to an externally applied voltage, change shape by a small amount. Examples of piezo material 52 include, but are not limited to, lead zirconate titanate (PZT). In other embodiments, material 52 may comprise other piezo ceramics or crystals.

In the particular example illustrated in FIGS. 1 and 4, three actuators 26 include three distinct patches or bands 60 of piezo material. Each band 60 corresponds to an opposite ejection portion 38 on substrate 22. Each band 60 is electrically isolated from adjacent bands and is connected to one or more power sources by electrical conductors 54, enabling bands 60 to be charged to distinct voltages.

Electrical conductors 54 comprise one or more electrically conductive structures in electrical contact with piezo material 52 and configured to cooperate with electrical conductor 46 to apply a voltage across piezo material 52. Electrical conductors 54 enable distinct voltages to be applied across different bands 60 of piezo material 52. As a result, fluid may be independently ejected through individual openings 40 to form a pattern or image of fluid upon a surface being printed upon. In one embodiment, electrical conductors 54 comprise a sputtered electrically conductive material, such as gold or indium tin oxide, patterned onto bands 60. In other embodiments, electrical conductors 54 may comprise other configurations or geometries of other electrically conductive materials.

Although print head 20 is illustrated as including three channels 32, three corresponding bands 60 of piezo material 52 and three distinct electrical conductors 54 on each side of substrate 22, in other embodiments, print head 20 may alternatively include a greater or fewer of such channels 32, bands 60 and conductors 54 on each side of substrate 22. For example, in one embodiment, print head 20 may include 50 channels 32, bands 60 and conductors 54 per inch on each side of substrate 22, with channels 32 being spaced approximately 500 um from center-center. Although print head 20 is illustrated as including a laminate 24 and an actuator 26 on both sides of substrate 22, in other embodiments, print head 20 may alternatively include a single laminate 24 and a single actuator 26 on a single side of substrate 22.

Overall, the architecture of print head 20 may facilitate fabrication of print head 20 at a lower cost and with greater design freedom. As noted above, laminates 24 may be formed independent of the formation of substrate 22 and provided in reels, lowering fabrication costs. The use of laminates 24 further enhances the ability to form different sized or dimensioned print heads 20 as desired. As shown by FIG. 3, the width W₁ of print head 20 may be enlarged or reduced as desired without or with minimal fabrication process changes. In the example illustrated, the completed structure may be singulated into print heads of various sizes.

Because laminates 24 include adhesive layer 44, laminates 24 may be more easily adhered or joined to substrate 22 without relying upon other more expensive and time-consuming processes such as anodic bonding. In those embodiments in which substrate 22 is formed from a polymeric material, fabrication costs are further reduced and the formation of fluidic features, such as channels 32 and openings 40, are achievable with a greater number and variety of processes while channels 32 and openings 40 may be provided with a larger variety of shapes and configurations, providing greater design freedom. For example, channels 32 and openings 40 may be molded, potentially reducing fabrication costs. The nozzle cross-sectional shapes might be triangular, oval, square, or any other manufacturable form.

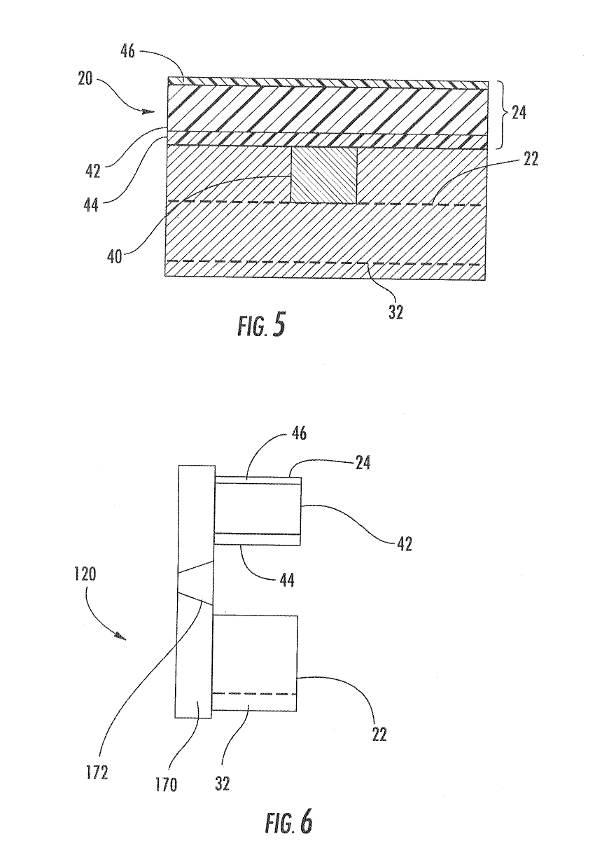

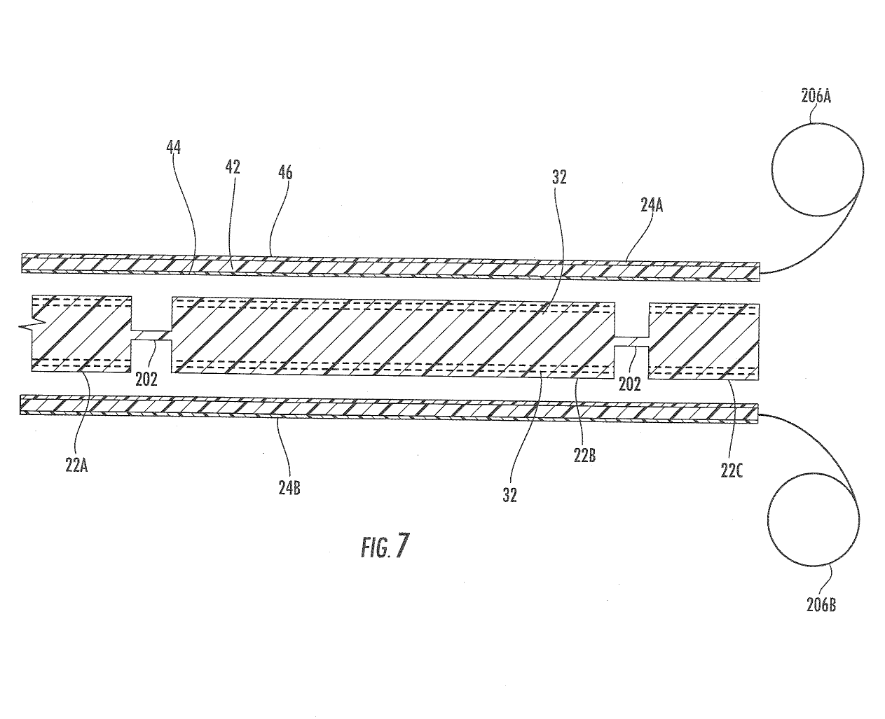

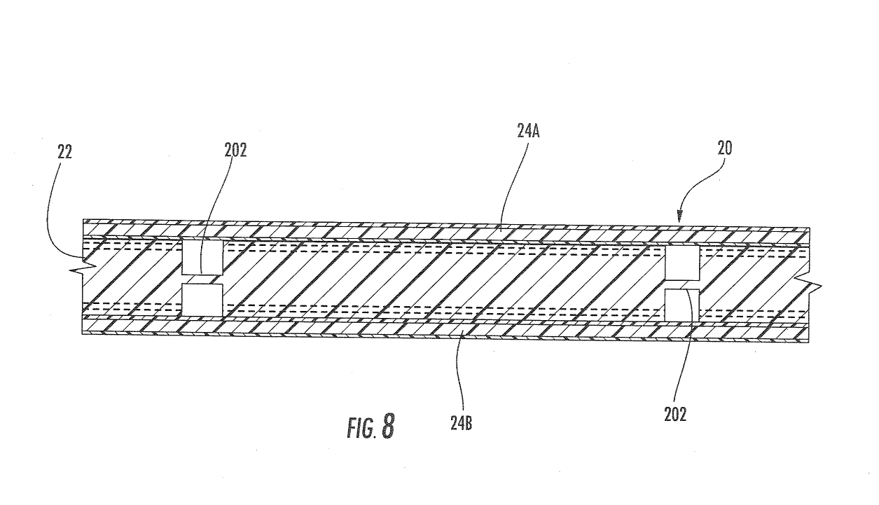

FIG. 6 is a sectional view of the portion of print head 120, another embodiment of print head 20 shown in FIG. 5. Print head 120 is similar to print head 20 except that print head 120 additionally includes orifice plate 170. Orifice plate 170 comprises a plate having orifices 172 (one of which is shown) extending therethrough. Orifices 172 have a controlled and well-defined size. Plate 70 is joined to edges of substrate 22 and of laminates 24 such that orifice 72 are positioned across openings 40. As a result, orifices 172 further control the rate and size of droplets ejected by print head 120. Orifice plate 170 may permit openings 40 to be larger in size or to be fabricated with greater tolerances. At the same time, providing controlled dimensions to orifices 172 of orifice plate 170 may be achieved with greater reliability and at a lower cost.

In one embodiment, orifice plate 170 is formed from a polymeric material, such as PET. In other embodiments, orifice plate 170 may be formed from metallic or ceramic materials. Orifices 172 may be formed by electroplating, laser processing and the like. In other embodiments, orifice plate 170 may be formed from other materials and orifices or 172 may be formed using other techniques.

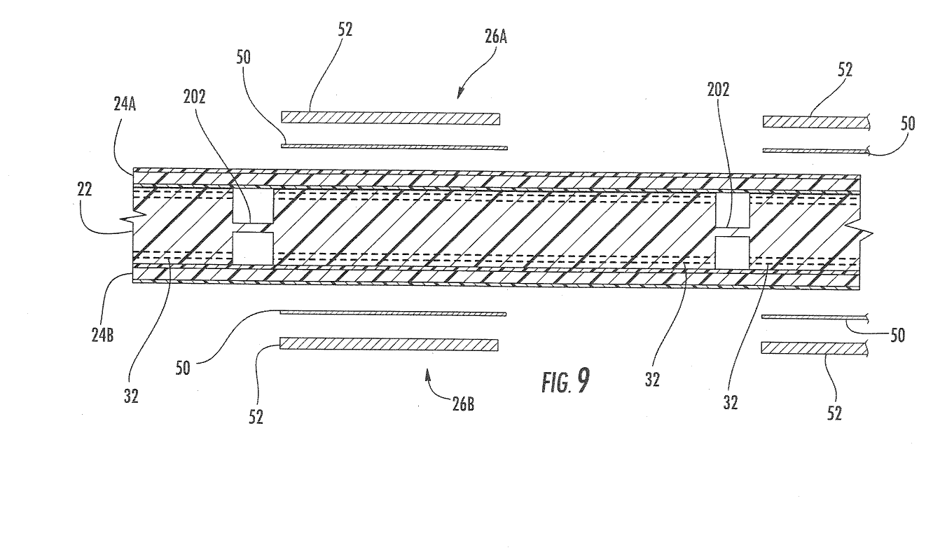

FIGS. 7-11 schematically illustrates one method for forming a plurality of print heads 20. As shown in FIG. 7, a multitude of interconnected substrates or substrate dies 22A, 22B and 22C (collectively referred to as substrates 22) are provided. Substrates 22 are connected by webs 202. Webs 202 comprise tabs or bands of material interconnecting and extending between consecutive substrates 22. Webs 202 interconnect substrates 22 and permit substrates 22 to be moved collectively and in unison. In particular embodiments where webs 202 are provided with sufficient rigidity or where the interconnected substrate 22 or pulled as a train of substrates 22, webs 202 may control or regulate spacing between consecutive substrates 22. In one embodiment, webs 202 continuously extend along an entire length (into the page) of each substrate 22. In other embodiments, each individual web 202 may include a single span or tab having a length less than the length of an adjacent substrate 22 or may include multiple spaced segments or tabs along a length of substrate 22.

Webs 202 facilitate subsequent singulation of the resulting multiple interconnected print heads into a multitude of individual print heads 20. In the particular embodiment illustrated, webs 202 have a reduced thickness as compared to the thickness of substrates 22 to facilitate such a subsequent singulation at controlled locations. In other embodiments, webs 202 may be otherwise formed so as to be weaker as compared to substrates 22. For example, webs 202 may include scores or breaks or may be formed from different materials that are weaker or that are more easily cut or severed.

In the particular embodiment illustrated, webs 202 are integrally formed as a single unitary body with substrates 22. In one embodiment, both substrates 22 and webs 202 are molded out of one or more polymeric materials. In one embodiment, substrates 22 and webs 202 are injection molded. As a result, multiple substrates 22 may be simultaneously formed and simultaneously moved in unison and appropriately positioned for securement to laminates 42. In still other embodiments, webs 202 may be omitted.

As further shown by FIG. 7, laminates 24A and 24B are fed from reels 206A and 206B (collectively referred to as reels 206), respectively, and are positioned on the opposite side of substrates 22 while substrates 22 are interconnected by webs 202. Because laminates 24 are fed from reels 206 fabrication costs are reduced. In addition, laminates 24 may be positioned adjacent to multiple interconnected substrates 22 in a near simultaneous fashion. As a result, multiple print heads 20 may be concurrently fabricated.

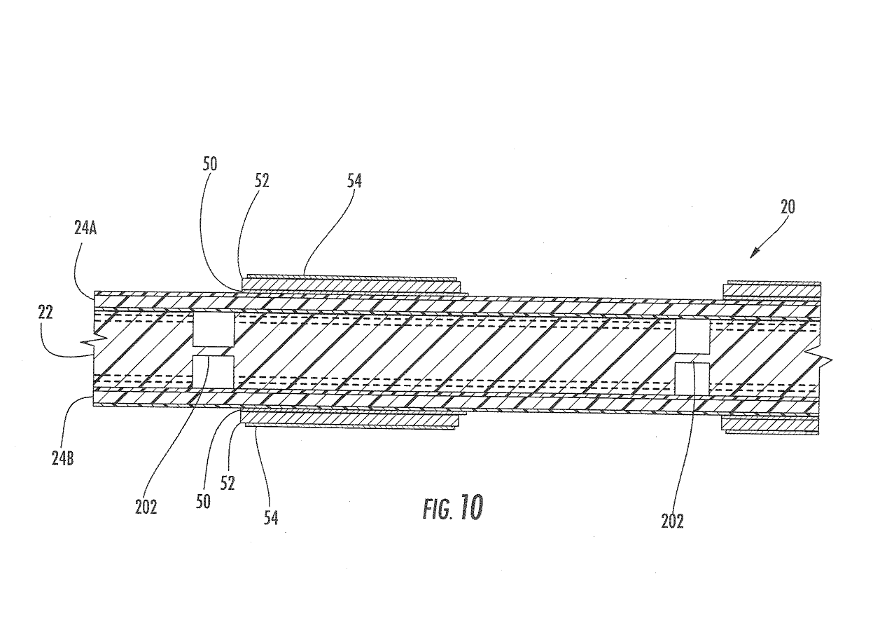

FIG. 8 illustrates bonding of laminates 24 to substrates 22. In one embodiment in which adhesive layer 44 comprises an epoxy, such as an epoxy photoresist like SU8, laminates 24 are bonded and baked to substrates 22, wherein the epoxy is cured during such baking. As shown by FIG. 8, laminates 24 continuously extend across and between consecutive substrates 22. Laminates 24 continuously extend across and span webs 202. Portions of laminates 24 which extend opposite to webs 202 are substantially identical to those portions of laminates 24 that extend opposite to substrates 22. In other words, neither adhesive layers 44 nor electrical conductors 46 are patterned so as to be omitted in those portions of the laminates 24 that overlap webs 202. A result, laminates 24 may be more easily fabricated with less patterning steps. Moreover, laminates 24 may be joined to substrates 22 with reduced alignment monitoring and control. In other embodiments, one or both of adhesive layer 44 or electric conductors 46 may be patterned so as to be omitted in those portions of laminates 24 that overlie webs 202.

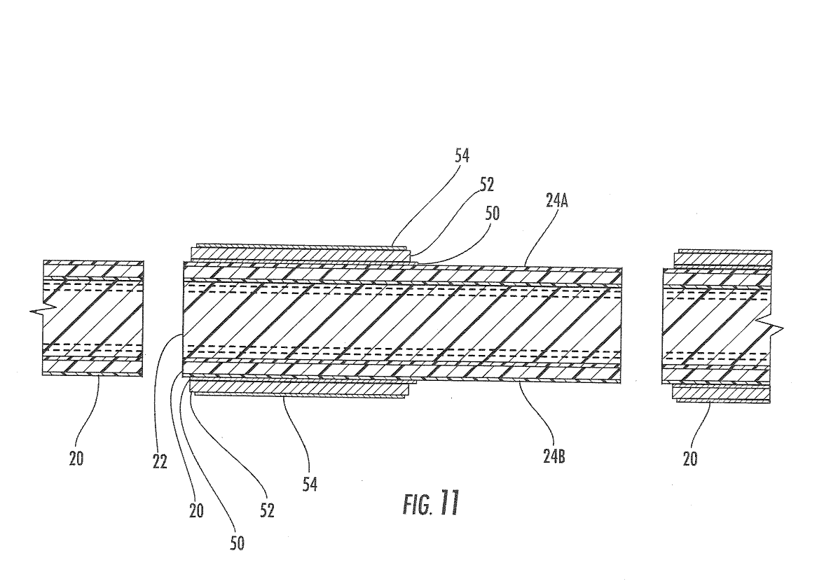

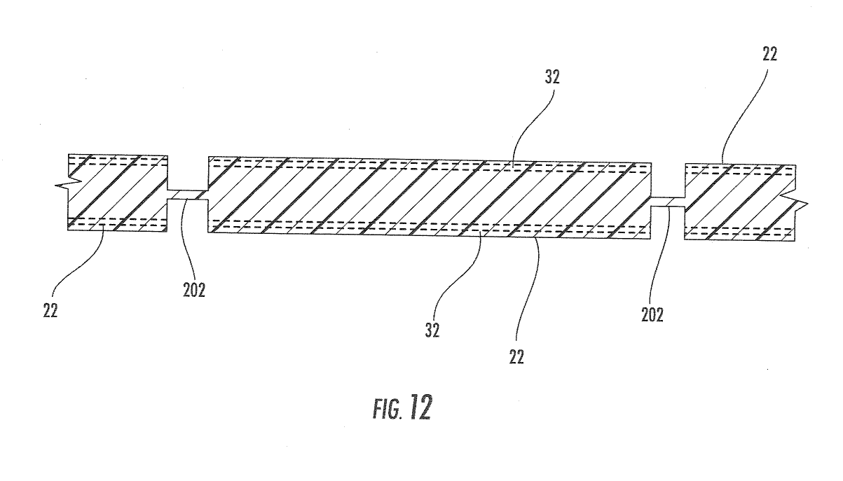

FIGS. 9 and 10 illustrate forming of actuators 26 on each of substrates 22. As shown by FIG. 9, adhesive layers 50 are formed upon electrical conductors 46. Thereafter, piezo materials 52 is deposited upon the adhesive layer 50. After placement of the piezo material 52 upon adhesive layer 50, adhesive layer 50 is cured In other embodiments, the adhesive layer 50 be applied to the piezo material 52 with the combination subsequently adhered to electrical conductor 46.

As shown by FIG. 10, electrical conductor 54 is formed upon piezo material 52. In one embodiment, electrical conductor 54 is formed by sputtering an electrically conductive material onto or electrical contact with piezo material 52. Examples of such an electrically conductive material include gold. Electrical conductor 54 is subsequently electrically connected to a voltage source.

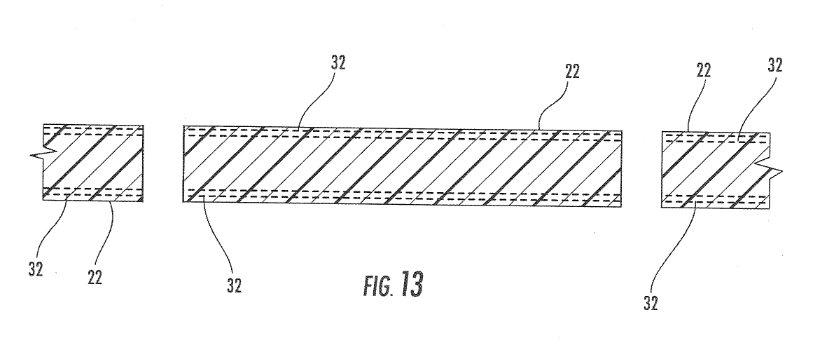

FIG. 11 illustrates singulation of the multiple interconnected print heads 20 resulting from the above described process. As shown in FIG. 11, print heads 20 are singulated or separated from one another at locations corresponding to webs 202. In one embodiment, such singulation may be performed mechanically by sawing, grinding and the like. In another embodiment, such singulation may be performed with lasers. In other embodiments, print heads 20 may be singulated in other fashions. The process described with respect to FIGS. 7-11 facilitates large-scale fabrication of multiple print heads with reduced processing and at a lower cost. The laminates 24 may be prefabricated. Laminates 24 may be positioned and concurrently joined to a multitude of print heads substrates 22. Because such multiple print heads are interconnected, reliable control over the positioning of such multiple interconnected print head substrates 22 may be more easily maintained.

FIGS. 12-17 illustrates another method for forming print head 20. The method illustrated in FIGS. 12-17 is similar to the method illustrated in FIGS. 7-11 except that substrates 22 and laminates 24 are singulated prior to being joined. As shown by FIG. 12, substrates 22 are initially formed and provided. As with the process illustrated in FIGS. 7-11, substrates 22 are interconnected by webs 202. Webs 202 interconnect substrates 22 and permit substrates 22 to be moved collectively and in unison. In particular embodiments where webs 202 are provided with sufficient rigidity, webs 202 may control or regulate spacing between consecutive substrates 22. In one embodiment, webs 202 continuously extend along an entire length (into the page) of each substrate 22. In other embodiments, each individual web 202 may include a single span or tab having a length less than the length of an adjacent substrate 22 or may include multiple spaced segments or tabs along a length of substrate 22.

Webs 202 facilitate subsequent singulation of the resulting multiple interconnected print heads into a multitude of individual print heads 20. In the particular embodiment illustrated, webs 202 have a reduced thickness as compared to the thickness of substrates 22 to facilitate such a subsequent singulation at controlled locations. In other embodiments, webs 202 may be otherwise formed so as to be weaker as compared to substrates 22. For example, webs 202 may include scores or breaks or may be formed from different materials that are weaker or that are more easily cut or severed.

In the particular embodiment illustrated, webs 202 are integrally formed as a single unitary body with substrates 22. In one embodiment, both substrates 22 and webs 202 are molded out of one or more polymeric materials. In one embodiment, substrates 22 and webs 202 are injection molded. As a result, multiple substrates 22 may be simultaneously formed and simultaneously moved in unison and appropriately positioned for securement to laminates 42. In still other embodiments, webs 202 may be omitted.

FIG. 13 illustrates interconnected substrates 22 being singulated. Such singulation may be performed mechanically by sawing, grinding and the like. In another embodiment, such singulation may be performed with lasers. In other embodiments, print heads 20 may be singulated in other fashions.

Such singulation occurs prior to substrates 22 being joined to laminates 24. Because substrates 22 are singulated prior to being overlaid with laminates 24, enhanced control during such singulation is achieved to reduce likelihood of damage to openings 40 along nozzle edge 41 of substrate 22. In some embodiments, singulation of substrates 22 prior to being joined to laminates 24 may be performed at a faster rate.

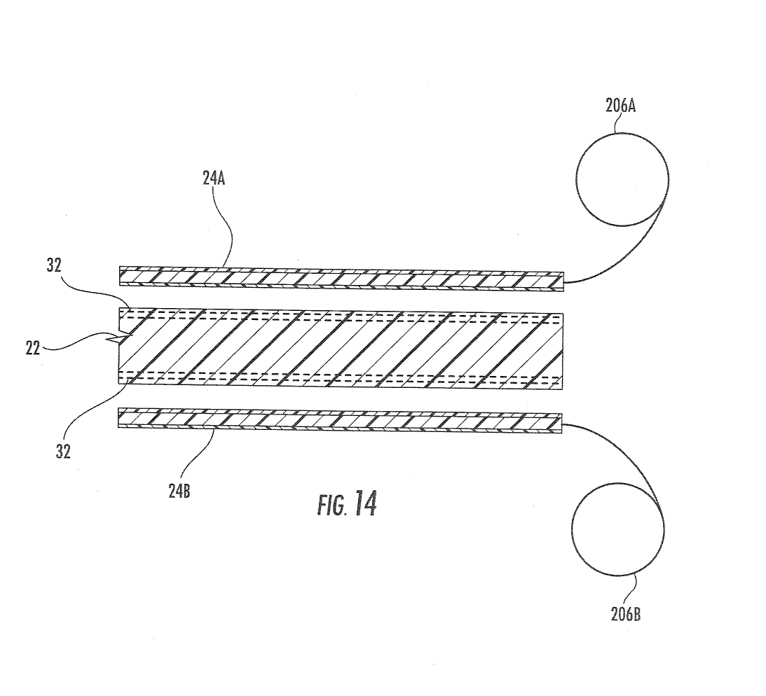

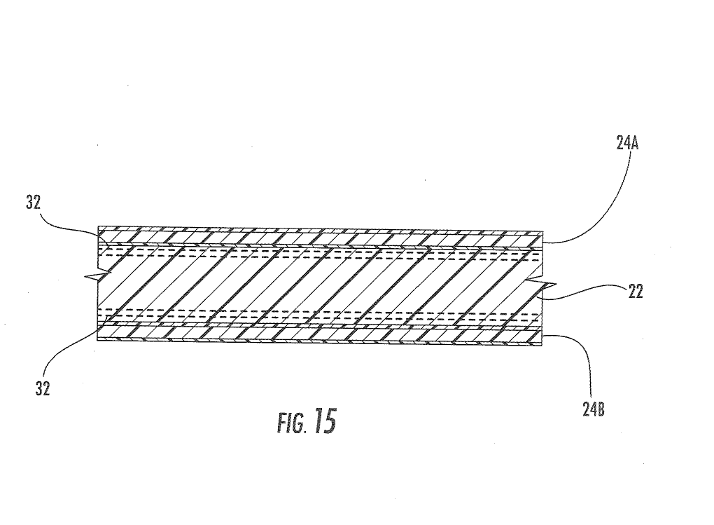

FIG. 14 illustrates positioning of laminates 24 across and opposite to a singulated, individual substrate 22. In the example illustrated, laminates 24 are fed from reels 206. Once laminates 24 are positioned opposite to substrate 22, laminates 24 are singulated or severed so as to have dimensions corresponding to those of substrate 22. In other words, laminates 24 are substantially coextensive with the opposite faces of substrate 22. In yet other embodiments, laminates 24 are singulated prior to being positioned opposite to substrate 22 and may be supplied from stacks or other non-reel storage arrangements.

FIG. 15 illustrates securement or joining of laminates 24 to substrate 22. In one embodiment in which adhesive layer 44 comprises an epoxy, such as an epoxy photoresist like SU8, laminates 24 are bonded and baked to substrates 22, wherein the epoxy is cured during such baking. In other embodiments, laminates 24 may be joined to substrate 22 with other adhesives or other bonding techniques.

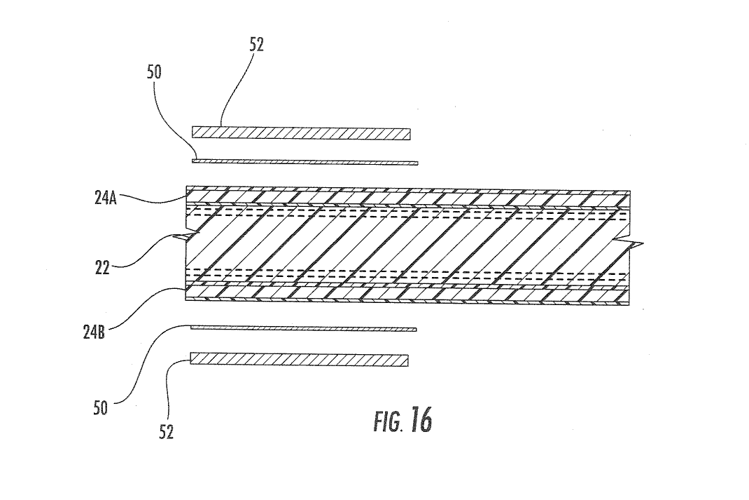

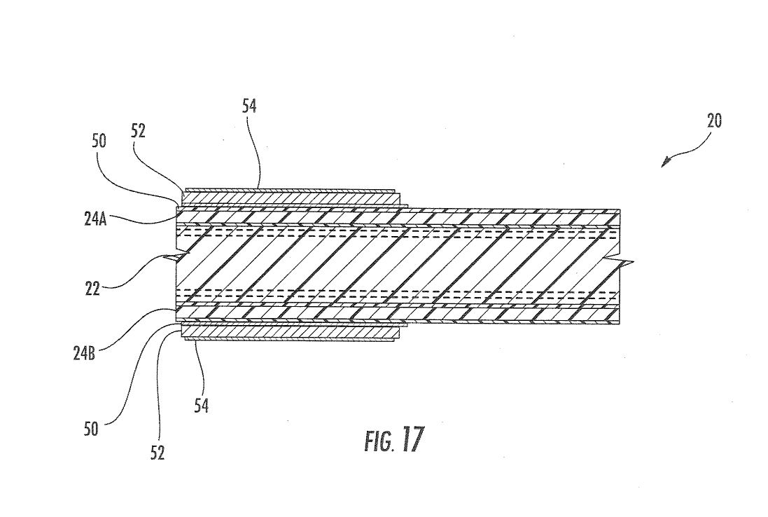

FIGS. 16 and 17 illustrate the addition of actuators 26. As shown by FIG. 16, adhesive layers 50 are formed upon electrical conductors 46. Thereafter, piezo materials 52 are deposited upon the adhesive layer 50. After placement of the piezo materials 52 upon adhesive layers 50, adhesive layers 50 are cured. In other embodiments, the adhesive layers 50 may be applied to the piezo materials 52 with the combination subsequently adhered to electrical conductors 46.

As shown by FIG. 17, electrical conductors 54 are formed upon piezo materials 52. In one embodiment, electrical conductors 54 are formed by sputtering an electrically conductive material onto or electrical contact with piezo material 52. Examples of such an electrically conductive material include gold. This sputtering step can occur at any stage in the assembly process. Electrical conductor 54 is subsequently electrically connected to a voltage source.

Although the methods illustrated in FIGS. 7-11 and FIGS. 12-17 depict channels 32, laminates 24 and actuators 26th formed along both opposite faces of substrates 22, in other embodiments, such features may alternatively be formed on a single face of substrate 22 using the same methods. Although particular steps have been described in noted orders, in other embodiments, the carrying out of steps may be performed in alternative orders. Additional steps or processes may also be added to the described methods.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. For example, although a feature is shown in as part of a particular combination, the feature may have equal applicability in other example embodiments with other combinations of features. Claims should not be restricted to the particular combinations of features illustrated in such example embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a print head laminate comprising:
a flexible glass layer;
a first electrical conductor on and in contact with a first side of the flexible glass layer; and
an adhesive layer on and in contact with a second opposite side of the flexible glass layer.

2. The apparatus of claim 1 further comprising a piezo material in electrical contact with the first electrical conductor.

3. The apparatus of claim 2 further comprising a second electrical conductor in electrical contact with the piezo material.

4. The apparatus of claim 2 further comprising a substrate having a face adhered to the laminate by the adhesive, the face including fluidic channels.

5. The apparatus of claim 4, wherein the laminate extends in a plane and wherein the channels extend along one or more axes parallel to the plane.

6. The apparatus of claim 5 further comprising an orifice plate across an edge of the substrate.

7. The apparatus of claim 4, wherein the substrate is polymeric.

8. The apparatus of claim 7, wherein the channels are molded channels.

9. A method comprising:
providing a first laminate comprising a first flexible glass layer, a first electrical conductor on and in contact with a first side of the flexible glass layer and a first adhesive layer on and in contact with a second opposite side of the first flexible glass layer; and
adhering the first laminate to a first face of at least one die substrate, the first face having first fluidic channels.

10. The method of claim 9 further comprising coupling a piezo material to the first electrical conductor.

11. The method of claim 10 further comprising electrically connecting a second electrical conductor to the piezo material.

12. The method of claim 9, wherein the at least one die substrate comprises a plurality of interconnected die substrates.

13. The method of claim 12 further comprising separating the substrates and portions of the adhered to first laminate into a plurality of print heads.

14. The method of claim 12, wherein the plurality of interconnected die substrates are integrally formed as a single unitary body from at least one polymeric material.

15. The method of claim 13, wherein the first fluidic channels are molded into the at least one polymeric material.

16. The method of claim 13, wherein the plurality of die substrates are homogenously formed from the least one polymeric material.

17. The method of claim 9, wherein the at least one die substrates comprises a single die substrate.

18. The method of claim 9, wherein the first laminate is applied as a web from a roll.

19. The method of claim 9, further comprising:
providing a second laminate comprising a second flexible glass layer, a second electrical conductor on and in contact with a first side of the second flexible glass layer and a second adhesive layer on and in contact with a second opposite side of the second flexible glass layer; and
adhering the second laminate to a second face of the at least one die substrate, the second face having second fluidic channels

20. A method comprising:
providing a plurality of substrates interconnected by webs, each substrate having a face with microfluidic channels extending along the face;
adhering a laminate across the plurality of substrates and across the webs;
forming actuators on the laminate, the actuators being configured to flex the laminate; and
singulating the plurality of substrates and portions of the laminate into a plurality of print heads.
